(19) United States
(12) Patent Application Publication
(10) Pub. No.: US 2025/0253354 A1
(43) Pub. Date: Aug. 7, 2025

(54) APPARATUS FOR MANUFACTURING ELECTRODE AND ELECTRODE ASSEMBLY

(71) Applicant: SK On Co., Ltd., Seoul (KR)

(72) Inventor: Taik Keun KIM, Daejeon (KR)

(21) Appl. No.: 18/929,621

(22) Filed: Oct. 29, 2024

(30) Foreign Application Priority Data
Feb. 7, 2024 (KR) 10-2024-0019054
Jun. 11, 2024 (KR) 10-2024-0075408

(51) Int. Cl. H01M 4/66; H01M 10/04

(52) U.S. Cl. CPC H01M 4/667; H01M 4/662; H01M 4/669; H01M 10/0459

(57) ABSTRACT

An apparatus for manufacturing an electrode according to an embodiment of the present disclosure includes: a supply portion supplying an electrode plate to which an electrode active material is applied; at least one thickness measuring portion measuring a thickness of the electrode plate; and at least one thickness reinforcing portion adding at least one reinforcing material to the electrode plate. An electrode assembly according to an embodiment of the present disclosure includes: a positive electrode plate to which a positive active material is applied, a negative electrode plate to which a negative active material is applied, and at least one of the positive electrode plate and the negative electrode plate includes at least one reinforcing material in at least a partial region thereof.

### CROSS-REFERENCE TO RELATED APPLICATION(S)

This patent document claims the priority and benefits of Korean Patent Application Nos. 10-2024-0019054 and 10-2024-0075408 filed on Feb. 7, 2024, and Jun. 11, 2024, the disclosures of which are incorporated herein by reference in their entirety.

### TECHNICAL FIELD

The present disclosure relates to an apparatus for manufacturing an electrode and electrode assembly.

### BACKGROUND

Batteries are widely used in small electronic devices such as mobile phones and laptop computers as well as medium and large mechanical devices such as electric vehicles (EV), and have the advantage of being rechargeable and reusable.

An electrode assembly may be formed of an electrode plate including a positive electrode plate and a negative electrode plate, and a separator separating the positive electrode plate and the negative electrode plate. An electrode assembly manufactured in a stack type, a stack-folding type, a roll type, or the like, may be accommodated in a case selected according to the purpose of use such as a pouch type, a square type, a cylindrical type, or the like, and an electrolyte may be injected into the case, and then, the case may be sealed, thereby manufacturing a battery cell.

A plurality of battery cells may be connected to a busbar to form a battery cell assembly. The battery cell assembly may be accommodated in a housing to form a battery module and/or a battery pack.

Meanwhile, an electrode may be manufactured by applying an electrode active material to a current collector. For example, a positive electrode active material and a negative electrode active material may be applied to a positive electrode current collector and a negative electrode current collector, respectively, thereby manufacturing a positive electrode plate and a negative electrode plate. In this case, the positive and negative active materials should be applied uniformly to the positive and negative plates. When there is a thickness deviation in the positive and negative plates, the quality of the battery cell may deteriorate.

### SUMMARY

According to an aspect of the present disclosure, an electrode plate having a uniform thickness is provided, and an electrode assembly having improved quality is provided.

Additionally, according to an aspect of the present disclosure, provided is an apparatus for manufacturing an electrode having improved manufacturing efficiency.

Additionally, the present disclosure may be widely applied in green technology fields such as solar power generation and wind power generation.

Additionally, the present disclosure may be applied to eco-friendly devices such as eco-friendly electric vehicles and hybrid vehicles to help ameliorate the effects of climate change by suppressing air pollution and greenhouse gas emissions.

An apparatus for manufacturing an electrode according to an example embodiment includes: a supply portion supplying an electrode plate to which an electrode active material is applied; at least one thickness measuring portion measuring a thickness of the electrode plate; and at least one thickness reinforcing portion adding at least one reinforcing material to the electrode plate.

In an embodiment of the present disclosure, the at least one thickness measuring portion may measure a center thickness value, a thickness value of a region in which a center of the electrode plate is disposed in a thickness direction cross-section of the electrode plate, and a side thickness value, a thickness value of the electrode plate in at least one end of both ends of the electrode plate.

In an embodiment of the present disclosure, the at least one thickness reinforcing portion adds the at least one reinforcing material to a region including at least one end of both ends of the electrode plate in a thickness direction cross-section of the electrode plate.

In an embodiment of the present disclosure, the apparatus for manufacturing an electrode may include a controller connected to the at least one thickness measuring portion and the at least one thickness reinforcing portion, and the at least one thickness measuring portion may measure a center thickness value, a thickness value of a region in which a center of the electrode plate is disposed in a thickness direction cross-section of the electrode plate, and a side thickness value, a thickness value of the electrode plate in at least one end of both ends of the electrode plate, and the controller may add at least one reinforcing material to the at least one end with the at least one thickness reinforcing portion when the side thickness value is smaller than the center thickness value.

In an embodiment of the present disclosure, the at least one reinforcing material is a material including at least one of aluminum, copper, nickel, titanium, and stainless steel.

In an embodiment of the present disclosure, the at least one thickness measuring portion may include: a first side measuring portion measuring a first side thickness value, a thickness of one end of the electrode plate; and a second side measuring portion measuring a second side thickness value, a thickness of the other end of the electrode plate.

In an embodiment of the present disclosure, the at least one thickness reinforcing portion may include: a first side reinforcing portion adding the at least one reinforcing material to one end of the electrode plate; and a second side reinforcing portion adding the at least one reinforcing material to the other end of the electrode plate.

In an embodiment of the present disclosure, the apparatus for manufacturing an electrode may include: a controller connected to the first side measuring portion, the second side measuring portion, the first side reinforcing portion, and the second side reinforcing portion, and the controller may add the at least one reinforcing material to the first side reinforcing portion or the second side reinforcing portion when a measurement side thickness difference value, a difference value between the first side thickness value and the second side thickness value, is greater than or equal to a preset target side thickness difference value.

In an embodiment of the present disclosure, the at least one thickness measuring portion may include: a thickness measuring member measuring the thickness of the electrode plate; and a first actuator moving the thickness measuring member.

In an embodiment of the present disclosure, the at least one thickness measuring portion may include at least one of an ultrasonic thickness measuring device and a radiological thickness measuring device.

In an embodiment of the present disclosure, the at least one thickness measuring portion may measure a thickness of the electrode plate during a transport of the electrode plate, and the thickness reinforcing portion may add the at least one reinforcing material to the electrode plate during the transport of the electrode plate.

In an embodiment of the present disclosure, the at least one thickness reinforcing portion adds the at least one reinforcing material to the electrode plate passing through the at least one thickness measuring portion.

In an embodiment of the present disclosure, the thickness reinforcing portion adds a plurality of reinforcing materials to one electrode plate.

The present disclosure according to another embodiment of the present disclosure provides an electrode assembly.

In an embodiment of the present disclosure, an electrode assembly according to an example embodiment of the present disclosure includes: a positive electrode plate to which a positive active material is applied; a negative electrode plate coated to which a negative active material is applied; and a separator interposed between the positive electrode plate and the negative electrode plate, and at least one of the positive electrode plate and the negative electrode plate include at least one reinforcing material in at least a partial region thereof.

In an embodiment of the present disclosure, at least one of the positive electrode plate and the negative electrode plate may include at least one reinforcing material in a region including an end.

In an embodiment of the present disclosure, the at least one reinforcing material may be a material including at least one of aluminum, copper, nickel, titanium, and stainless steel.

In an embodiment of the present disclosure, the positive electrode plate may be formed so that a region to which the positive electrode active material is applied and a region to which the positive electrode active material is not applied are alternately arranged in a width direction of the positive electrode plate, and the negative electrode plate may be formed so that a region to which the negative active material is applied and a region to which the negative active material is not applied are alternately arranged in the width direction of the negative electrode plate.

In an embodiment of the present disclosure, in the positive electrode plate, the positive electrode active material may be stripe-coated in a length direction of the positive electrode plate, and wherein in the negative electrode plate, the negative electrode active material may be stripe-coated in the length direction of the negative electrode plate.

According to an aspect of the present disclosure, an electrode plate having a uniform thickness is provided, and an electrode assembly having improved quality is provided.

Additionally, according to an aspect of the present disclosure, an apparatus for manufacturing an electrode having improved manufacturing efficiency is provided.

Additionally, the present disclosure may be widely applied in green technology fields such as solar power generation and wind power generation.

Additionally, the present disclosure may be applied to eco-friendly devices such as eco-friendly electric vehicles and hybrid vehicles for preventing climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 is a schematic perspective view of an apparatus for manufacturing an electrode according to an embodiment of the present disclosure.

FIG. 2 is a schematic view of a cross-section taken along line I-I′ of FIG. 1.

FIG. 3 is a schematic view of a cross-section in the thickness direction of an electrode plate.

FIG. 4 is a schematic perspective view of an apparatus manufacturing an electrode according to another embodiment of the present disclosure.

FIG. 5 is a schematic view of a cross-section taken along line [symbol] - [symbol] ′ of FIG. 4.

FIG. 6 is a schematic perspective view of an apparatus for manufacturing an electrode according to another embodiment of the present disclosure.

FIG. 7 is a schematic perspective view of an apparatus for manufacturing an electrode according to another embodiment of the present disclosure.

FIG. 8 is a schematic view of a cross-section taken along line [symbol] - [symbol] ′ of FIG. 7.

FIG. 9 is a schematic view of a portion of an electrode plate manufactured by an apparatus for manufacturing an electrode according to an embodiment of the present disclosure.

FIG. 10 is a schematic view of an electrode manufacturing system including an apparatus for manufacturing an electrode according to an embodiment of the present disclosure.

FIG. 11 schematically illustrates a portion of an electrode manufacturing system including an apparatus for manufacturing an electrode according to another embodiment of the present disclosure.

FIG. 12 is a schematic perspective view of an electrode assembly according to an embodiment of the present disclosure.

FIG. 13 schematically illustrates a cross-section taken along line IV-IV′ of FIG. 12.

### DETAILED DESCRIPTION

In order to help understand the description of an embodiment of the present disclosure, elements described with the same symbol in the attached drawings are the same elements. Some components of the attached drawings are exaggerated, omitted, or schematically illustrated, and sizes of each component does not completely reflect actual sizes.

Additionally, in order to clarify the gist of the present disclosure, descriptions of elements and techniques well known by conventional techniques will be omitted, and hereinafter, the present disclosure will be described in detail with reference to the attached drawings.

Hereinafter, an X-axis illustrated in the drawings is a longitudinal direction of an electrode plate 10, a Y-axis is the width direction of the electrode plate 10, and a Z-axis is a thickness direction of the electrode plate 10. However, these are directions arbitrarily set for the convenience of understanding, and the above-described directions may be changed.

Additionally, the electrode may refer to an electrode of a lithium ion secondary battery, and the electrode may be an electrode plate 10 having a plate shape or a flat shape.

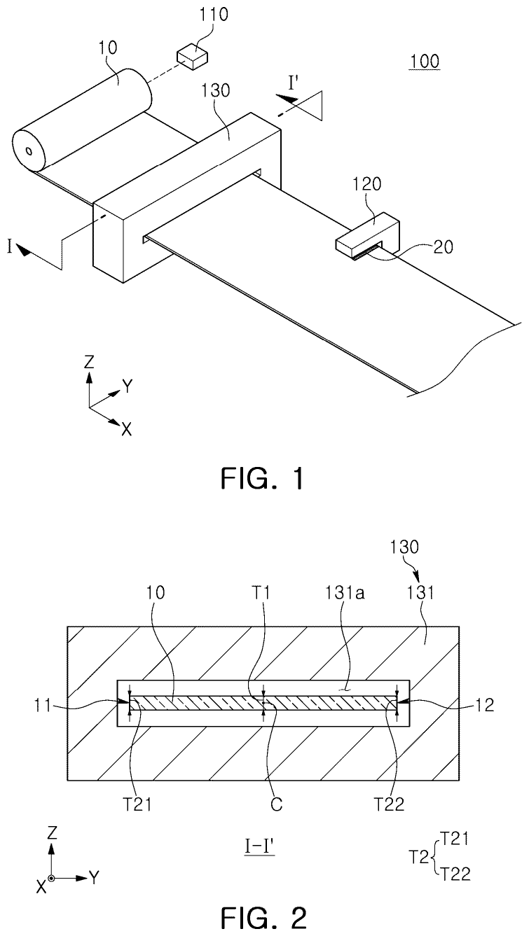

FIG. 1 is a schematic perspective view of an apparatus 100 for manufacturing an electrode according to an embodiment of the present disclosure. As illustrated in FIG. 1, the apparatus 100 for manufacturing an electrode according to an embodiment of the present disclosure includes a supply portion 110 supplying an electrode plate 10 to which an electrode active material 30 is applied, at least one thickness measuring portion 130 measuring a thickness of the electrode plate 10, and at least one thickness reinforcing portion 120 adding at least one reinforcing material 20 to the electrode plate 10.

The at least one thickness reinforcing portion 120 may add at least one reinforcing material 20 to at least one region of an edge region and a center region of the electrode plate 10.

The edge region and the center region of the electrode plate 10 may be regions on the electrode plate 10 to which the electrode active material is applied.

The electrode plate 10 mentioned below may include a positive electrode plate and a negative electrode plate, and the electrode active material 30 may include a positive electrode active material and a negative electrode active material. In this case, when the electrode plate 10 is a positive electrode plate, the electrode active material 30 applied to the electrode plate 10 may be a positive electrode active material, and when the electrode plate 10 is a negative electrode plate, the electrode active material 30 applied to the electrode plate 10 may be a negative electrode active material.

The electrode plate 10 illustrated in FIG. 1 may be a positive electrode plate or a negative electrode plate.

The positive electrode plate may be manufactured by applying the positive electrode active material to a positive electrode current collector, and the negative electrode plate may be manufactured by applying the negative electrode active material to a negative electrode current collector.

The positive electrode current collector may be a material including aluminum, stainless steel, nickel, titanium, copper, or alloys thereof. The positive electrode active material may be in the form of a slurry in which not only the cathode active material but also a binder, a conductive agent, a dispersant, and the like, are mixed and stirred.

The negative electrode current collector may be formed of a material including copper, gold, stainless steel, nickel, aluminum, titanium, or alloys thereof. The negative electrode active material may be in the form of a slurry in which not only the negative electrode active material but also a binder, a conductive agent, a dispersant, and the like, are mixed and stirred.

Additionally, as an example, the positive electrode current collector and the negative electrode current collector may be formed of a material including a metal such as Co, Mn, or Li.

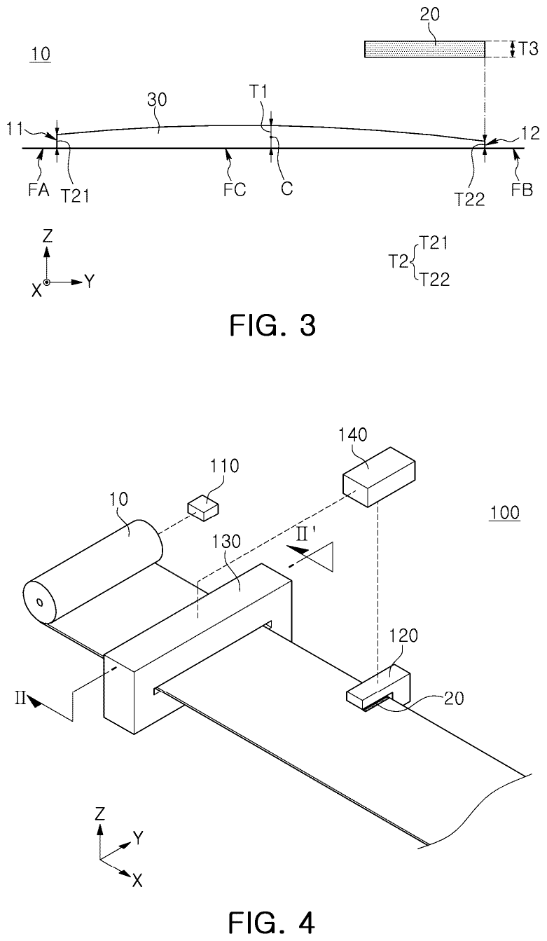

The electrode plate 10 may include an active material region FC (see FIG. 3) to which the positive electrode active material or the negative electrode active material is applied, and an uncoated regions FA and FC (see FIG. 3) to which the positive active material or the negative electrode active material is not applied. The uncoated regions FA and FC (see FIG. 3) may be formed only on one edge in the electrode plate 10 in a Y-axis direction, or may be formed on both edges in the electrode plate 10 in the Y-axis direction. The present disclosure is not necessarily limited thereto.

Meanwhile, the supply portion 110 may supply the electrode plate 10. For example, the supply portion 110 may supply a positive electrode plate or a negative electrode plate. The electrode plate 10 mentioned below may be a positive electrode plate or a negative electrode plate.

The electrode plate 10 may be unwound by the supply portion 110 in a state of being wound in a roll shape. In an embodiment, the supply portion 110 may be an unwinder. The supply portion 110 may supply the electrode plate 10 at a constant speed. In FIG. 1, the supply portion 110 may supply the electrode plate 10 in an +X-direction. For example, the electrode plate 10 may be supplied and/or transported to a process for separating into unit electrode plates having a constant specification. For this purpose, a separate transport device, or the like, may be applied.

The thickness measuring portion 130 may be disposed to follow the supply portion 110 in the +X-direction. The thickness measuring portion 130 may measure a thickness of the electrode plate 10 provided in the form of a plate in a Z-axis direction. The thickness measuring portion 130 may measure the thickness of the electrode plate 10 while the electrode plate 10 is transported.

For example, when the electrode plate 10 is a positive electrode plate, the thickness of the positive electrode plate may refer to a thickness of the positive electrode current collector, and a thickness of a positive electrode mixture applied to the positive electrode current collector. Accordingly, the thickness of the electrode plate 10 may include a thickness of the positive electrode mixture applied to the positive electrode current collector. Even if the electrode plate 10 is a negative electrode plate, the thickness of the electrode plate 10 may be measured using the same principle.

The thickness measuring portion 130 may measure the thickness of the electrode plate 10 at a specific point of the electrode plate 10, and may measure the thickness of the electrode plate 10 in a width direction (Y-axis direction) of the electrode plate 10 as a whole. In this case, the specific point may be selected from the active material region (FC of FIG. 3) to which the electrode active material is applied.

An X-axis direction length of a region of the electrode plate 10 in which a thickness thereof is measured may be appropriately selected depending on electrode manufacturing environments, and the present disclosure is not necessarily limited thereto.

In an embodiment, the thickness measuring portion 130 may measure the thickness of the electrode plate 10 using at least one of ultrasonic waves and radiation. In some cases, the thickness measuring portion 130 may obtain image information of the electrode plate 10 by utilizing a vision system, or the like.

The thickness reinforcing portion 120 may add at least one reinforcing material 20 to the electrode plate 10 according to a thickness value of the electrode plate 10 measured by the thickness measuring portion 130. In an embodiment, the thickness reinforcing portion 120 may selectively add the reinforcing material 20 to the electrode plate 10. For example, when the thickness value of the electrode plate 10 measured by the thickness measuring portion 130 is in a range satisfying a preset thickness value, the thickness reinforcing portion 120 may not add the reinforcing material 20 to the electrode plate 10.

In an embodiment, the thickness reinforcing portion 120 may add at least one reinforcing material 20 to a region of the electrode plate 10 to which the electrode active material 30 is applied. A region of the electrode plate 10 to which the electrode active material 30 is not applied is an uncoated region (FA, FB of FIG. 3), and the present disclosure may selectively add at least one reinforcing material 20 to a region other than the uncoated region (FA, FB of FIG. 3).

The added reinforcing material 20 may be fixed to the electrode plate 10. For example, the thickness reinforcing portion 120 may add the reinforcing material 20 to a region including ends 11 and 12 of the active material region (FC of FIG. 3), in an electrode assembly including the electrode plate 10. According thereto, the thickness of the electrode plate 10 may be reinforced without deteriorating charge and discharge performance of the electrode plate 10, and the quality of the electrode plate 10 and the electrode assembly including the electrode plate 10 may be improved.

In an embodiment, the thickness reinforcing portion 120 may include a welder. For example, the welder includes a laser welder or an ultrasonic welder. And a controller 140 is connected to the welder. The thickness reinforcing portion 120 may weld the reinforcing material 20 to the electrode plate 10. However, the present disclosure is not necessarily limited thereto, and the thickness reinforcing portion 120 may attach the reinforcing material 20 to the electrode plate 10 or add the reinforcing material 20 to the electrode plate 10 by other methods.

Accordingly, the thickness of the electrode plate 10 may be reinforced in a region in which the thickness of the electrode plate 10 is relatively thin.

In an embodiment, at least one reinforcing material 20 may be a material including at least one of aluminum, copper, nickel, titanium, and stainless steel.

As an example, at least one reinforcing material 20 may be aluminum. Aluminum may be bonded to both the positive and negative electrode plates.

Additionally, as an example, at least one reinforcing material 20 may be formed of another material that does not react chemically and electrically with the electrode plate 10.

Additionally, an area of at least one reinforcing material 20 is narrower than an area of the electrode plate 10, and at least one reinforcing material 20 may have a thickness less than or equal to the thickness of the electrode plate 10. A shape of the reinforcing material 20 in an X-Y plane may be polygonal or circular.

Additionally, at least one reinforcing material 20 may be provided as a piece. At least one reinforcing material 20 may include a plurality of reinforcing materials 20. For example, the plurality of reinforcing materials 20 may be a plurality of aluminum pieces. However, the present disclosure is not necessarily limited thereto, and this may be appropriately selected depending on the electrode manufacturing environments, specifications of the electrode plate 10, or the like.

In an embodiment, at least one thickness measuring portion 130 may measure the thickness of the electrode plate 10 during a transport of the electrode plate 10, and the thickness reinforcing portion 120 may add at least one reinforcing material 20 to the electrode plate 10 during the transport of the electrode plate 10.

Accordingly, a thickness measuring task of the electrode plate 10 and a thickness reinforcing task of the electrode plate 10 may be completed during the transport of the electrode plate 10. Additionally, a separate process for reinforcing the thickness of the electrode plate 10 becomes unnecessary, and the productivity and manufacturing efficiency of the electrode plate 10 and the electrode assembly including the electrode plate 10 may be improved.

FIG. 2 is a schematic view of a cross-section taken along line I-I′ of FIG. 1. As illustrated in FIG. 2, at least one thickness measuring portion 130 according to an embodiment of the present disclosure may measure a center thickness value T1, a thickness value of a region in which a center C of the electrode plate 10 is disposed in a thickness direction cross-section of the electrode plate 10, and a side thickness value T2, a thickness value of the electrode plate 10 in at least one end of both ends of the electrode plate 10.

As an example, the center thickness value T1 may be a region in which a width directional (Y-direction) center C of the electrode plate 10 of the active material region (FC of FIG. 3) to which the electrode active material 30 is applied is disposed. In this case, the both ends of the electrode plate 10 may be ends of the active material area (FC of FIG. 3) in which the electrode active material 30 exists in the electrode plate 10. Specific details thereof will be described below.

The both ends of the electrode plate 10, that is, the both ends of the active material region (FC of FIG. 3) to which the electrode active material 30 is applied, may include a first end 11 and a second end 12. The first end 11 may include one edge of the electrode plate 10, and the second end 12 may include the other edge of the electrode plate 10. In this case, the first end 11 may include one edge of the active material region (FC of FIG. 3) of the electrode plate 10 to which the electrode active material 30 is applied, and the second end 12 may include the other edge of the active material region (FC of FIG. 3) of the electrode plate 10 to which the electrode active material 30 is applied.

In the thickness direction cross-section of the electrode plate 10, the center C of the electrode plate 10 may include a center of figure or a center of gravity of the electrode plate 10 in a Y-Z plane. For example, the center of figure and the center of gravity of the electrode plate 10 may be the same.

Additionally, in an embodiment, the center C of the electrode plate 10 may include a point corresponding to half of a length value of the electrode plate 10 in the Y-axis direction in the Y-Z plane.

The center thickness value T1 of the electrode plate 10 may be a straight-line distance of the electrode plate 10 in the Z-axis direction from a point in which the center C of the electrode plate 10 is disposed.

The side thickness value T2 of the electrode plate 10 may include a plurality of side thickness values T2. The plurality of side thickness values T2 may include a first side thickness value T21, a straight-line distance of the electrode plate 10 in the Z-axis direction from the first end 11 of the electrode plate 10, and a second side thickness value T22, a straight-line distance of the electrode plate 10 in the Z-axis direction from the second end 12 of the electrode plate 10.

In an embodiment, at least one thickness measuring portion 130 may include at least one thickness measuring device 131. The thickness measuring device 131 may include a first measuring region 131a which is a hollow region. An area of the first measuring region 131a in the Y-Z plane may be wider than an area of the electrode plate 10. The electrode plate 10 may pass through the first measuring region 131a in the X-axis direction, and a thickness thereof may be measured.

In an embodiment, at least one thickness measuring device 131 may include at least one of an ultrasonic thickness measuring device and a radiographic thickness measuring device.

For example, at least one thickness measuring device 131 may include at least one of an X-ray gauge and a computed tomography (CT) camera. The thickness measuring device 131 may measure the thickness of the electrode plate 10 in a non-contact manner. Accordingly, surface damage of the electrode plate 10 and deterioration of the quality of the electrode plate 10 may be prevented. However, the type of the thickness measuring device 131 is not necessarily limited by the present disclosure, and may be replaced with another measuring device such as a sensor.

In an embodiment, the thickness measuring device 131 may measure thicknesses of the center C of the electrode plate 10, the first end 11 of the electrode plate 10, and the second end 12 of the electrode plate 10. Additionally, in an embodiment, the thickness measuring device 131 may measure the thickness of the electrode plate 10 over an entire width of the electrode plate 10 in the Y-axis direction.

FIG. 3 is a schematic view of a cross-section of the electrode plate 10 in a thickness direction (Z-axis direction). As illustrated in FIG. 3, the electrode plate 10 may include a current collector F in the form of a foil and an electrode active material 30 applied to the current collector F.

In an embodiment, the electrode plate 10 may be an aluminum foil or a copper foil.

The current collector F may be a positive current collector or a negative current collector. The electrode active material 30 may be an electrode active material 30 suitable for the type of the current collector F, and may be a positive active material or a negative active material.

The current collector F may include at least one uncoated region FA or FB, and at least one uncoated region FA or FB may include a plurality of uncoated regions FA and FB. If necessary, the current collector F may be provided with only one uncoated region FA or FB. In the uncoated regions FA and FB, the electrode active material 30 may not be applied. A region of the current collector F to which the electrode active material 30 is applied may be an active material region FC.

The electrode active material 30 may be applied over an entire active material region FC, or may be applied to the active material region FC in a certain pattern. Additionally, the electrode active material 30 may be discontinuously applied to the active material region FC in the Y-axis direction. However, the present disclosure is not necessarily limited thereto.

The electrode plate 10 may be provided as described above, but for the convenience of understanding, the active material region FC will be referred to as the electrode plate 10 below, and the uncoated regions FA and FB may be excluded from the electrode plate 10 described below. The ends 11 and 12 of the electrode plate 10 may be ends of the active material region FC excluding the uncoated regions FA and FB.

In an embodiment of the present disclosure, at least one thickness reinforcing portion 120 may add at least one reinforcing material 20 to a region including at least one of both ends of the electrode plate 10, i.e., both ends of the active material region FC, in a thickness directional cross-section of the electrode plate 10.

The electrode plate 10 illustrated in FIG. 3 may be in a state in which an application of the electrode active material 30 is completed. In FIG. 3, the electrode plate 10 may have a first side thickness value T21 in the first end portion 11, and may have a second side thickness value T22 in the second end portion 12. For example, the first side thickness value T21 may be a thickness value of one side (−Y-direction) edge of the active material region FC, and the second side thickness value T22 may be a thickness value of the other side (+Y-direction) edge of the active material region FC.

The first side thickness value T21 may have a value greater than the second side thickness value T22. The first side thickness value T21 may have a value greater than or equal to the center thickness value T1. In this case, the first side thickness value T21, the second side thickness value T22, and the center thickness value T1 may all denote absolute values.

The second side thickness value T22 may have a value less than or equal to the center thickness value T1. In some cases, the second side thickness value T22 may have a value less than at least one of the center thickness value T1 and the first side thickness value T21.

The cross-section of the electrode plate 10 illustrated in FIG. 3 is an example, which illustrates that the first side thickness value T21 is less than the center thickness value T1 and is greater than the second side thickness value T22. However, this is only an example, and in the present disclosure, when a thickness deviation occurs between the first end 11 and the second end 12, at least one reinforcing material 20 may be added to a region in which a thickness value thereof is relatively thin, among the first end 11 and the second end 12.

For example, as illustrated in FIG. 3, when the second side thickness value T22 has a smaller value than the first side thickness value T21, a thickness in the first end 11 of the electrode plate 10 and a thickness in the second end 12 may be different from each other, so that the thickness of the electrode plate 10 or thicknesses of both edges may have a deviation.

Accordingly, the present disclosure may increase the second side thickness value T22 by bonding at least one reinforcing material 20 to the second end 12 having the second side thickness value T22.

In an embodiment, a reinforcing material thickness value T3, a Z-axis direction thickness of at least one reinforcing material 20, may be less than or equal to twice a thickness difference value, which is a difference between the center thickness value T1 of the electrode plate 10 and the side thickness value T2 of the electrode plate 10. According thereto, it may be possible to prevent the electrode plate 10 from being damaged around the reinforcing material 20 or the electrode plate 10 from being cracked.

The side thickness value T2 may include at least one of the first side thickness value T21 and the second side thickness value T22.

The side thickness value T2 may be a thickness value in a region having a thinner thickness, among the first end 11 and the second end 12. That is, the side thickness value T2 may be a smaller value among the first side thickness value T21 and the second side thickness value T22.

As illustrated in FIG. 3, when the second side thickness value T22 is smaller than the first side thickness value T21, the side thickness value T2 may be the second side thickness value T22. Accordingly, the reinforcing material 20 may be added to a region including the second end 12 having the second side thickness value T22. In this case, the reinforcing material thickness value T3, a thickness value of the added reinforcing material 20, may be less than or equal to twice the thickness difference value, which is a difference between the center thickness value T1 and the second side thickness value T22.

In some cases, the second side thickness value T22 may have a value greater than or equal to the first side thickness value T21 and/or the center thickness value T1.

A width of the reinforcing material 20 in the Y-axis direction is not necessarily limited by the present disclosure, and when assuming that a line connecting the center C of the electrode plate 10 and the second end 12 is drawn, the width thereof may be appropriately selected in a range in which the drown straight line may be horizontal or parallel to the Y-axis.

If necessary, the width of the reinforcing material 20 in the Y-axis direction may be changed in the width direction of the electrode plate 10 in the Y-axis direction. For example, the width of the reinforcing material 20 may be gradually thinner as the reinforcing material 20 approaches the center C of the electrode plate 10. However, the present disclosure is not necessarily limited thereto. However, the specifications of the reinforcing material 20 may be appropriately changed depending on whether there is a thickness deviation of the electrode plate 10 and the amount of the thickness deviation.

FIG. 4 is a schematic perspective view of an apparatus 100 for manufacturing an electrode according to another embodiment of the present disclosure.

As illustrated in FIGS. 3 and 4, the apparatus 100 for manufacturing an electrode according to another embodiment of the present disclosure may further include a controller 140 connected to the at least one thickness measuring portion 130 and the at least one thickness reinforcing portion 120, and the at least one thickness measuring portion 130 may measure a center thickness value T1, a thickness value of a region in which the center C of the electrode plate 10 is disposed in a thickness direction cross-section of the electrode plate 10, and a side thickness value T2, a thickness value of the electrode plate 10 in at least one end of the ends of the electrode plate 10, and the controller 140 may add the at least one reinforcing material 20 to the at least one end with the at least one thickness reinforcing portion 120 when the side thickness value T2 is smaller than the center thickness value T1.

In an embodiment, the controller 140 may display or notify the side thickness value T2, the center thickness value T1, and a difference value between the side thickness value T2 and the center thickness value T1 in any one of visual, auditory and tactile methods.

Accordingly, the thickness of the electrode plate 10 may be measured, and an operation of reinforcing a thin portion of the electrode plate 10 to make the thickness of the electrode plate 10 uniform may be automatically performed. Additionally, when the thickness of the electrode plate 10 is non-uniform, this may be quickly notified to the worker.

This may contribute not only to improving productivity and manufacturing efficiency, but also to improving the precision and accuracy of the measured value. Accordingly, the reliability of the apparatus 100 for manufacturing an electrode may be improved.

For example, the controller 140 may be at least one of a control unit, a controller and a processor of a Computer Aided Engineering (CAE) device, microcontroller and microcontroller unit. However, the present disclosure is not necessarily limited thereto.

Additionally, in an embodiment, the at least one thickness reinforcing portion 120 may add at least one reinforcing material 20 to the electrode plate 10 passing through the at least one thickness measuring portion 130.

When the measurement side thickness value T2 is thinner than a reference thickness value of a preset side thickness value T2, the at least one thickness reinforcing portion 120 may increase the thickness of the electrode plate 10 so that the reference thickness value of the preset side thickness value T2 and the measurement side thickness value T2 are at least the same. The operation of the at least one thickness reinforcing portion 120 may be performed by the controller 140.

The at least one thickness reinforcing portion 120 may add at least one reinforcing material 20 to the electrode plate 10 to increase the thickness of the electrode plate 10.

At least one thickness reinforcing portion 120 may be disposed to face at least one end of both ends of the electrode plate 10.

At least one thickness reinforcing portion 120 may be disposed to follow at least one thickness measuring portion 130 in a transport direction or an +X-direction of the electrode plate 10.

Accordingly, at least one reinforcing material 20 may be added to the electrode plate 10 passing through at least one thickness measuring portion 130. Accordingly, while transporting the electrode plate 10, the operation of measuring the thickness of the electrode plate 10 and the operation of making the thickness of the electrode plate 10 uniform may be sequentially performed.

Accordingly, while transporting the electrode plate 10, the thickness of the electrode plate 10 may be measured and the thickness of the electrode plate 10 may be reinforced. This may contribute to improved manufacturing efficiency and productivity.

In an embodiment, at least a portion of at least one thickness reinforcement portion 120 may face the reinforcing material 20 and the electrode plate 10. At least one thickness reinforcement portion 120 may complete the bonding of the reinforcing material 20 to the electrode plate 10 at one time, or may bond a portion of the reinforcing material 20 to the electrode plate 10, and may then bond the remaining portion to the electrode plate 10.

Additionally, the thickness reinforcement portion 120 may bond the reinforcing material 20 to the electrode plate 10 while moving along the electrode plate 10. For example, when the thickness reinforcement portion 120 is a welding machine, a welding torch, a welding head, or the like, may bond the reinforcing material 20 to the electrode plate 10 while moving along the electrode plate 10 and the reinforcing material 20.

Additionally, in an embodiment, the reinforcing material thickness value T3, a thickness of the reinforcing material 20 in the Z-axis direction, may be determined in consideration of a thickness difference value, a difference value between the first side thickness value T21 and the second side thickness value T22 of the electrode plate 10.

For example, when the thickness value of the reinforcing material 20 in the Z-axis direction is set to be the same as the thickness difference value, the difference value between the first side thickness value T21 and the second side thickness value T22, the reinforcing material 20 should be continuously added to the electrode plate 10 in the X-axis direction.

That is, when a section having a thickness difference value, the difference value between the first side thickness value T21 and the second side thickness value T22 in the electrode plate 10 is continuous during a certain section in an X-axis, the reinforcing material 20 should be added to an entire section in which the thickness of the electrode plate 10 has the thickness difference value.

On the other hand, when the thickness value of the reinforcing material 20 in the Z-axis direction exceeds the thickness difference value, the difference value between the center thickness value T1 of the electrode plate 10 and the side thickness value of the electrode plate 10, and is less than twice the thickness difference value, the reinforcing material 20 may be added discontinuously or intermittently from the electrode plate 10 in the X-axis direction.

That is, when the section having the thickness difference value, which is the difference value between the first side thickness value T21 and the second side thickness value T22 in the electrode plate 10, is continuous during a certain section in the X-axis, if the thickness value of the reinforcing material 20 in the Z-axis direction is greater than the thickness difference value, the difference value between the center thickness value T1 of the electrode plate 10 and the side thickness value of the electrode plate 10 and is less than twice the thickness difference value, the reinforcing material 20 may be added discontinuously or intermittently in a section in which the thickness of the electrode plate 10 is the thickness difference value.

This means that when the thickness value of the reinforcing material 20 in the Z-axis direction is greater than the thickness difference value, the difference value between the center thickness value T1 of the electrode plate 10 and the side thickness value of the electrode plate 10, the reinforcing material 20 may reinforces the thickness of the electrode plate 10 thickly or a region that may cover the thickness difference may be widened.

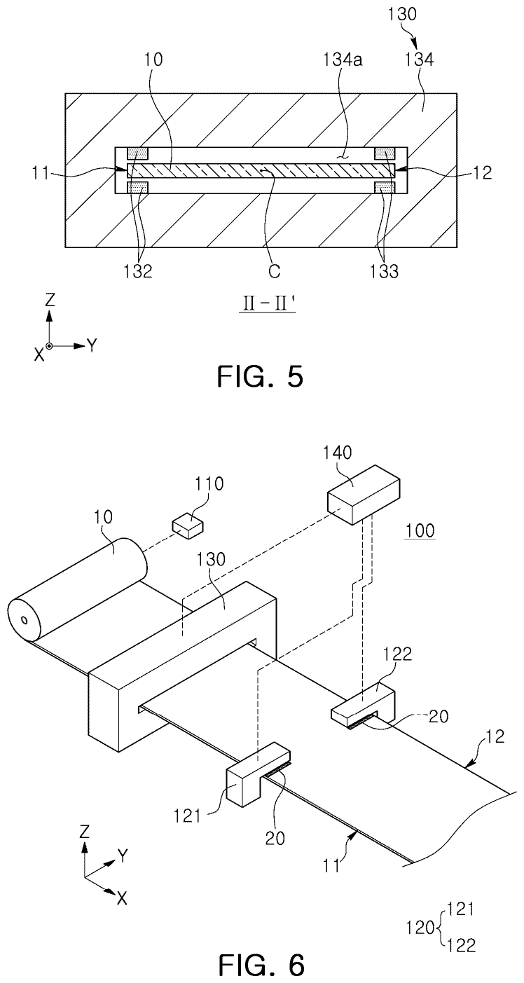

FIG. 5 is a schematic view of a cross-section taken along line [symbol] - [symbol] ′ of FIG. 4. As illustrated in FIG. 5, in another embodiment of the present disclosure, at least one thickness measuring portion 130 may include a first side measuring portion 132 measuring a first side thickness value T21, a thickness value of one end of the electrode plate 10, and a second side measuring portion 133 measuring a second side thickness value T22, a thickness value of the other end of the electrode plate 10.

In this case, one end may be a first end 11, and the other end may be a second end 12. The first side measuring portion 132 may measure only a thickness of the first end 11, and the second side measuring portion 133 may measure only the thickness of the second end 12. Here, the first side thickness value T21 refers to the thickness of the first end 11, and the second side thickness value T22 refers to the thickness of the second end 12. Additionally, at least one thickness measuring portion 130 may further include a center measuring portion measuring a thickness of the center C of the electrode plate 10. The center measuring portion may be provided with the same mechanical device as the first side measuring portion 132 and the second side measuring portion 133.

The first side measuring portion 132 and the second side measuring portion 133 may be provided in plural. A plurality of first side measuring portions 132 may be spaced apart from each other by equal intervals in a longitudinal direction (X-axis direction) of the electrode plate 10 or may be spaced apart from each other by different separation distances. The same principle as described above may be applied to the second side measuring portion 133.

In another embodiment, the first side measuring portion 132 may measure a thickness of the first end 11 and a thickness from the first end 11 to a certain section in the direction of the center C of the electrode plate 10. Additionally, the second side measuring portion 133 may measure a thickness of the second end 12 and a thickness from the second end 12 to a certain section in the direction of the center C of the electrode plate 10. In this case, the thickness values of the electrode plate 10 measured by the first side measuring portion 132 may be plural, and the thickness values of the electrode plate 10 measured by the second side measuring portion 133 may also be plural. In this case, the first side thickness value T21 may be a minimum value, among the plurality of thickness values measured by the first side measuring portion 132, and the second side thickness value T22 may also be a minimum value, among the plurality of thickness values measured by the second side measuring portion 133.

In this case, the reinforcing material 20 may be added to a point having a minimum value, among the minimum value of the first side thickness value T21 and the minimum value of the second side thickness value T22. For example, when the thickness of the second end 12 is the minimum value, the second side thickness value T22 may be the thickness of the second end 12. In this case, the thickness of the reinforcing material 20 may be less than or equal to twice a difference value between a maximum value of the first side thickness value T21 and a thickness value of the second end 12.

Additionally, in an embodiment, the first side measuring portion 132 and the second side measuring portion 133 may be provided in plural.

A plurality of first side measuring portions 132 may be spaced apart from each other with the electrode plate 10 interposed therebetween, and a plurality of second side measuring portions 133 may also be spaced apart from each other with the electrode plate 10 interposed therebetween.

Additionally, the first side measuring portion 132 and the second side measuring portion 133 may measure the thickness of the electrode plate 10 in real time and/or online, and may transmit the measured value to the controller 140.

FIG. 6 is a schematic perspective view of an apparatus 100 for manufacturing an electrode according to another embodiment of the present disclosure. As illustrated in FIG. 6, in another embodiment of the present disclosure, at least one thickness reinforcement portion 120 may include a first side reinforcing portion 121 that adds at least one reinforcing material 20 to one end of the electrode plate 10 and a second side reinforcing portion 122 that adds at least one reinforcing material 20 to the other end of the electrode plate 10.

In this case, the one end may be the first end 11, and the other end may be the second end 12.

The first side reinforcing portion 121 and the second side reinforcing portion 122 may be disposed to face each other with the electrode plate 10 interposed therebetween. For example, the first side reinforcing portion 121 and the second side reinforcing portion 122 may be symmetrical with the electrode plate 10 interposed therebetween. In addition, the first side reinforcing portion 121 and the second side reinforcing portion 122 may be disposed in the same position in the longitudinal direction (X-axis direction) of the electrode plate 10. That is, X-axis coordinate values of the first side reinforcing portion 121 and the second side reinforcing portion 122 may be identical to each other.

The first side reinforcing portion 121 and the second side reinforcing portion 122 may be provided in plural. A plurality of first side reinforcing portions 121 may face the first end 11, and a plurality of second side reinforcing portions 122 may face the second end 12. In this case, the plurality of first side reinforcing portions 121 may be spaced apart from each other in the X-axis direction, and the plurality of second side reinforcing portions 122 may also be spaced apart from each other in the X-axis direction. Accordingly, the thickness of the electrode plate 10 may be quickly reinforced.

Referring to FIGS. 3 to 6, another embodiment of the present disclosure will be described. The controller 140 may be connected to the first side measuring portion 132, the second side measuring portion 133, the first side reinforcing portion 121, and the second side reinforcing portion 122.

When the measurement side thickness difference value, the difference value between the first side thickness value T21 and the second side thickness value T22, is greater than or equal to a preset target side thickness difference value, the controller 140 may add at least one reinforcing material 20 to the first end 11 and the second end 12 using the first side reinforcing portion 121 or the second side reinforcing portion 122.

The measurement side thickness difference value may refer to an absolute value of a difference value between the first side thickness value T21 and the second side thickness value T22 measured in real time by the first side measuring portion 132 and the second side measuring portion 133, and the target side thickness difference value may refer to an absolute value of a difference value between the first side thickness value T21 and the second side thickness value T22 set in advance.

The target side thickness difference value refers to an allowable thickness difference value, and when the measurement side thickness difference value is less than the target side thickness difference value, the controller 140 may not add the reinforcing material 20 to the first end 11 and the second end 12.

The controller 140 may selectively add the reinforcing material 20 to a region in which a thickness thereof is significantly thin, among the first end 11 and the second end 12, according to the difference value between the measurement side thickness difference value and the target side thickness difference value.

In an embodiment, the reinforcing material thickness value T3, which is a thickness of at least one reinforcing material 20 in the Z-axis direction illustrated in FIG. 3, may be greater than or equal to the absolute value of the difference value between the first side thickness value T21 and the second side thickness value T22.

For example, when the first side thickness value T21 is 120 μm and the second side thickness value T22 is 113 μm, the absolute value of the difference value between the first side thickness value T21 and the second side thickness value T22 may be 7. In an embodiment, the reinforcing material thickness value T3 of at least one reinforcing material 20 may be 20, and the thickness of the reinforcing material 20 may be 20 μm.

In this manner, in an embodiment of the present disclosure, the reinforcing material thickness value T3 of at least one reinforcing material 20 may be in a range of 10 or more and 40 or less, and the unit thereof may be μm.

According to an embodiment of the present disclosure, the thickness of the electrode plate 10 may be reinforced while preventing damage to the electrode plate 10. At the same time, the number of reinforcing materials 20 added in the longitudinal direction (X-axis direction) of the electrode plate 10 may be minimized.

Meanwhile, when the thickness of the reinforcing material 20 is equal to the absolute value of the difference value between the first side thickness value T21 and the second side thickness value T22, that is, 7 μm, a length of the reinforcing material 20 in the longitudinal direction of the electrode plate 10 (the length in the X-axis direction) may be equal to an X-axis direction length of the section in which a thickness deviation exists in the electrode plate 10.

That is, a plurality of reinforcing materials 20 may be added continuously to a relatively thin region of the electrode plate 10, or a length of a single reinforcing material 20 may be made the same as a length of the relatively thin region so that the single reinforcing material 20 may be added to the electrode plate 10.

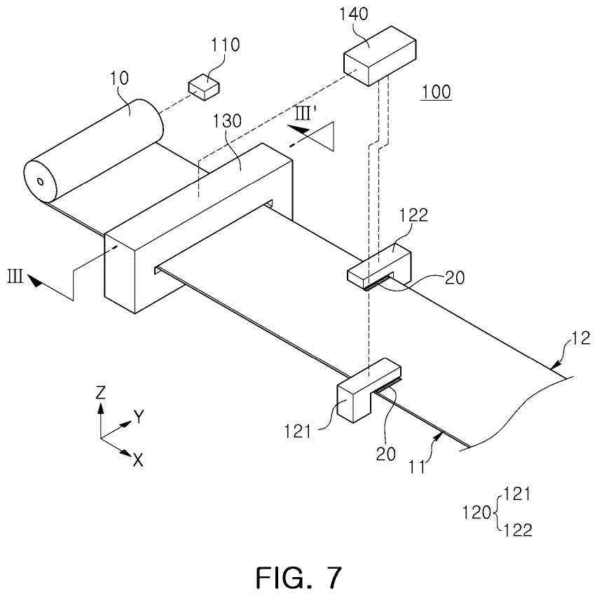

FIG. 7 is a schematic perspective view of an apparatus 100 for manufacturing an electrode according to another embodiment of the present disclosure. As illustrated in FIG. 7, the first side reinforcing portion 121 and the second side reinforcing portion 122 may be spaced apart from each other with the electrode plate 10 interposed therebetween, and may be disposed so as not to face each other based on the center C (see FIG. 5) of the electrode plate 10 or an extension line of the center (C of FIG. 5) in the X-axis direction.

In an embodiment, the thickness measuring portion 130, the first side reinforcing portion 121, and the second side reinforcing portion 122 may be connected to the controller 140. Or the thickness measuring portion 130, the first side reinforcing portion 121, and the second side reinforcing portion 122 may be electrically connected to the controller 140. Additionally, the thickness measuring portion 130, the first side reinforcing portion 121 and the second side reinforcing portion 122 may communicate wirelessly or by wire with the controller 140.

The first side reinforcing portion 121 and the second side reinforcing portion 122 may have different coordinate values in the X-axis. For example, a distance in which the first side reinforcing portion 121 is spaced apart from the thickness measuring portion 130 in the +X-direction may be longer than a distance in which the second side reinforcing portion 122 is spaced apart from the thickness measuring portion 130 in the +X-direction. Alternatively, the opposite may be the case. In this manner, the first side reinforcing portion 121 and the second side reinforcing portion 122 may be disposed to be misaligned with each other in the longitudinal direction of the electrode plate 10.

Additionally, in an embodiment, the first side reinforcing portion 121 and the second side reinforcing portion 122 may be provided in plural, and a plurality of first side reinforcing portions 121 may be spaced apart from each other by equal intervals in the length direction of the electrode plate 10 or may be spaced apart from each other by different intervals. The same principle as described above may be applied to a plurality of second side reinforcing portions 122.

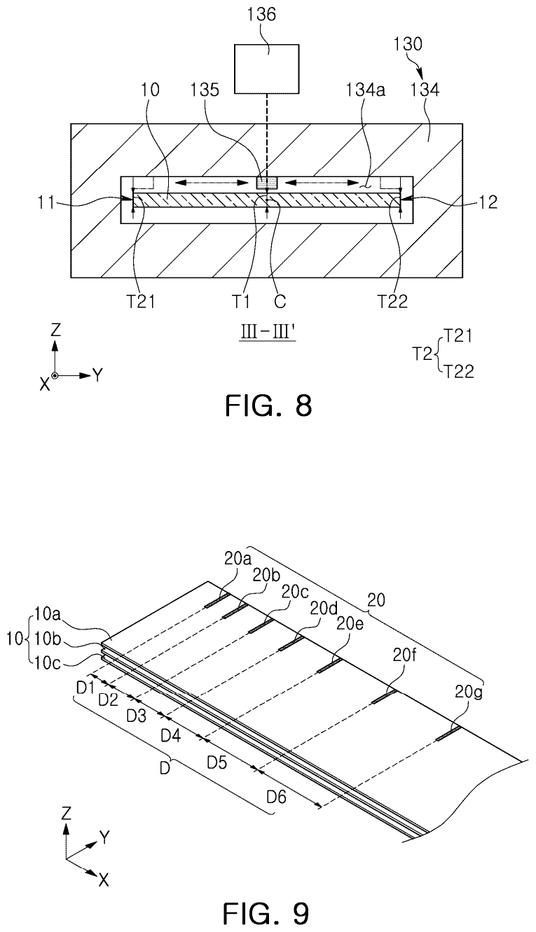

FIG. 8 is a schematic view of a cross-section taken along line [symbol] - [symbol] ′ of FIG. 7. As illustrated in FIG. 8, in another embodiment of the present disclosure, at least one thickness measuring portion 130 may include a thickness measuring member 135 measuring the thickness of the electrode plate 10 and an actuator 136 moving the thickness measuring member 135.

The thickness measuring member 135 may be supported by a support 134. The support 134 may include a second measuring region 134a which is a hollow area, and an electrode plate 10 may be inserted into the second measuring region 134a. The electrode plate 10 may be moved in the X-direction.

For example, the thickness measuring member 135 may be provided as a measuring device such as a thickness measuring sensor, a thickness measuring device 131, a length or distance measuring device, or the like, but the type thereof is not necessarily limited thereto. The thickness measuring member 135 may measure a thickness of the center C, and thicknesses of the first end 11 and the second end 12 of the electrode plate 10. Additionally, in an embodiment, the thickness measuring member 135 may measure a thickness of a region including the center C, the first end 11 and the second end 12 of the electrode plate 10.

For example, the thickness measuring member 135 may measure a thickness value of the electrode plate 10 before the reinforcing material 20 is added, and may also measure the thickness value of the electrode plate 10 after the reinforcing material 20 is added. That is, the thickness measuring member 135 may measure at least one thickness value of a thickness values of the electrode plate 10 to which the reinforcing material 20 is added and a thickness value of the electrode plate 10 to which the reinforcing material 20 is not added.

In an embodiment, the thickness measuring member 135 may be moved on the support 134 by the actuator 136. The actuator 136 may provide force capable of moving the thickness measuring member 135. For example, the thickness measuring member 135 may be connected to an LM guide, a ball screw, or the like, which is provided in the support 134. The LM guide rail, the ball screw, or the like, may be arranged in a parallel manner in a width direction of the electrode plate 10 on the support 134.

Accordingly, a path along which the thickness measuring member 135 may move in a width direction of the electrode plate 10 may be set. The actuator 136 may be provided as a motor, a robot arm, or the like, but the present disclosure is not necessarily limited thereto.

The actuator 136 may provide force that enables the thickness measuring member 135 to move along the LM guide rail, the ball screw, or the like. In an embodiment, the actuator 136 and the thickness measuring member 135 may be connected to the controller 140.

The thickness measuring member 135 may measure the thickness of the center C of the electrode plate 10, the thickness of the first end 11 of the electrode plate 10, and the thickness of the second end 12 of the electrode plate 10. The thickness measuring member 135 may measure the center thickness value T1, the first side thickness value T21, and the second side thickness value T22. The thickness measuring member 135 may move in the width direction of the electrode plate 10 and may measure the thickness of the electrode plate 10.

Accordingly, the convenience of the thickness measuring operation may be improved.

FIG. 9 is a schematic view of a portion of an electrode plate 10 manufactured by an apparatus 100 for manufacture of an electrode according to an embodiment of the present disclosure. In FIG. 9, the uncoated regions FA and FB (see FIG. 3) of the electrode plate 10 is omitted.

As illustrated in FIG. 9, in another embodiment of the present disclosure, the thickness reinforcing portion 120 may add a plurality of reinforcing materials 20 to one electrode plate 10.

As illustrated in FIG. 3 and FIG. 9, an operation of adding reinforcing materials 20 to the electrode plate 10 may be performed multiple times. Additionally, a plurality of reinforcing materials 20 may be bonded to one electrode plate 10. The plurality of reinforcing materials 20 may be bonded to at least one of the first end 11 and the second end 12 of one electrode plate 10. For example, the reinforcing material 20 may be bonded to at least one of the ends of the active material region FC, a region of one electrode plate 10 to which the electrode active material 30 is applied. In this case, the end may include a first end 11, one end of the electrode plate 10 in the width direction (Y-direction), and a second end 12, the other end thereof.

Meanwhile, the electrode plate 10 illustrated in FIG. 9 may include a first electrode plate 10a, a second electrode plate 10b, and a third electrode plate 10c. In this case, the first electrode plate 10a, the second electrode plate 10b, and the third electrode plate 10c may all be positive plates or may all be negative plates. Alternatively, the first electrode plate 10a, the second electrode plate 10b, and the third electrode plate 10c may include positive and negative plates. The positive and negative plates may be alternately stacked or arranged in a thickness direction (Z-direction). In some cases, the positive and negative plates may be wound.

In this manner, the apparatus for manufacturing an electrode may continuously produce or manufacture positive and negative plates. The manufactured positive and negative plates may be transported to a post-process or stored separately. In some cases, the positive and negative plates may be cut into unit electrode plates having a certain standard. The positive and negative plates may be stacked or wound together with a separator in the post-process. The separator may be interposed between the positive and negative plates, and may isolate the negative and positive plates from each other.

Materials of the reinforcing materials 20 added to the first electrode plate 10a, the second electrode plate 10b, and the third electrode plate 10c may all be the same, or may be different materials.

Positions in which the reinforcing materials 20 are bonded to the first electrode plate 10a, the second electrode plate 10b, and the third electrode plate 10c may be different.

Taking the first electrode plate 10a as an example, the plurality of reinforcing materials 20 may be bonded to the first electrode plate 10a. The plurality of reinforcing materials 20 may be bonded to the first electrode plate 10a during the transport of the first electrode plate 10a.

The plurality of reinforcing materials 20 may include the first to seventh reinforcing materials 20a, 20b, 20c, 20d, 20e, 20f and 20g, but the number thereof is not necessarily limited thereto.

The plurality of reinforcing materials 20 may be bonded to at least one of the first end 11 (see FIG. 8) and the second end 12 (see FIG. 8) of the electrode plate 10.

The plurality of reinforcing materials 20 may be spaced apart from each other in the longitudinal direction (X-axis direction) of the electrode plate 10.

A separation distance D between the plurality of reinforcing materials 20 may include a plurality of separation distances D. The plurality of separation distances D may be separation distances D between the plurality of reinforcing materials 20 in the X-axis direction.

The plurality of separation distances D may include first to sixth separation distances D1, D2, D3, D4, D5 and D6. The first separation distance D1 may be a separation distance between the first reinforcing material 20a and the second reinforcing material 20b. The second separation distance D2 may be a separation distance between the second reinforcing material 20b and the third reinforcing material 20c. The third separation distance D3 may be a separation distance between the third reinforcing material 20c and the fourth reinforcing material 20d. The fourth separation distance D4 may be a separation distance between the fourth reinforcing material 20d and the fifth reinforcing material 20e. The fifth separation distance D5 may be a separation distance between the fifth reinforcing material 20e and the sixth reinforcing material 20f. The sixth separation distance D6 may be a separation distance between the sixth reinforcing material 20f and the seventh reinforcing material 20g.

For example, the plurality of separation distances D, the first separation distance D1 may be the shortest, the sixth separation distance D6 may be the longest, and the separation distance may increase linearly from the first separation distance D1 to the sixth separation distance D6.

In this case, the thickness of the first reinforcing material 20a may be the thinnest, and the thickness of the seventh reinforcing material 20g may be the thickest. The thickness of the reinforcing material 20 may sequentially increase from the first reinforcing material 20a to the seventh reinforcing material 20g.

In this manner, as the thickness of the reinforcing material 20 becomes thicker, the separation distance between the reinforcing members 20a, 20b, 20c, 20d, 20e, 20f and 20g may increase. For example, when the thickness of the second end 12 of the electrode plate 10 is continuously thinner in the longitudinal direction of the electrode plate 10 than the thickness of the first end 11, the first to seventh reinforcing materials 20a, 20b, 20c, 20d, 20e, 20f and 20g may be added only to the second end 12 of the electrode plate 10, and the thickness of the first reinforcing material 20a may be the thinnest and the thickness of the seventh reinforcing material 20g may be the thickest.

Additionally, the thickness of the reinforcing material may sequentially increase from the first reinforcing material 20a to the seventh reinforcing material 20g. Accordingly, a value of the first separation distance D1 may be the smallest and a value of the sixth separation distance D6 may be the largest. In this manner, the separation distance between the reinforcing materials 20a, 20b, 20c, 20d, 20e, 20f and 20g may increase as the thickness of the reinforcing material 20 increases.

In this manner, the plurality of reinforcing materials 20 may be disposed to be spaced apart from each other in a section in which the thickness of the electrode plate 10 is continuously thin in the longitudinal direction of the electrode plate 10, thereby obtaining the same effect as an effect of bonding the reinforcing materials 20 to an entire section in which the thickness of the electrode plate 10 is thin.

That is, even if the plurality of reinforcing materials 20 having relatively short lengths in the X-axis direction are intermittently added to the electrode plate 10, the same effect as an effect of continuously adding one reinforcing material 20 having a relatively long length in the X-axis direction to the electrode plate 10 may be obtained. In this case, as the thickness of the reinforcing material 20 becomes relatively thicker, the separation distance between the plurality of reinforcing materials 20 may increase, and as the thickness of the reinforcing material 20 becomes relatively thinner, the separate distance between the plurality of reinforcing materials 20 may decrease.

Referring to FIGS. 8 and 9, more specifically, when the thickness of the electrode plate 10 in the first end 11 of the electrode plate 10 is 150 μm, the thickness of the electrode plate 10 in the second end 12 is 145 μm, and the thickness of the second end 12 is continuously 5 μm thinner than the thickness of the first end 11 in the longitudinal direction (X-axis direction) of the electrode plate 10, the plurality of reinforcing materials 20 may be added to the second end 12.

In this case, a width of the fifth reinforcing material 20e in the Y-axis direction may be 10 mm, a length of the fifth reinforcing material 20e in the X-axis direction may be 3 mm, and a thickness of the fifth reinforcing material 20e in the Z-axis direction may be selected in a range of 3 μm or more and 8 μm or less. In this case, the fifth separation distance D5 may be formed between the fifth reinforcing material 20e and the sixth reinforcing material 20f.

In this state, when the sixth reinforcing material 20f having a thickness in a range of 5 μm or more and 10 μm or less is bonded to the electrode plate 10, the seventh reinforcing material 20g may be added in a position spaced apart from the sixth reinforcing material 20f by a separation distance greater than the fifth separation distance D5. In this manner, as the thickness of the reinforcing material 20 increases, the thickness of the electrode plate 10 may increase, and as the thickness of the electrode plate 10 increases, the separation distance D of the reinforcing materials 20 may increase.

For example, when the thickness of the electrode plate 10 in the first end 11 of the electrode plate 10 is 150 μm, the thickness of the electrode plate 10 in the second end 12 is 145 μm, and the thickness of the second end 12 is continuously 5 μm thinner than the thickness of the first end 11 in the longitudinal direction (X-axis direction) of the electrode plate 10, the plurality of reinforcing materials 20 may be added to the second end 12.

In this case, among the plurality of reinforcing materials 20, a width of the fifth reinforcing material 20e in the Y-axis direction may be 10 mm, a length of the fifth reinforcing material 20e in the X-axis direction may be 3 mm, and a thickness of the fifth reinforcing material 20e in the Z-axis direction may be 8 μm. Then, a thickness of the second end 12 to which the fifth reinforcing material 20e is bonded may be 153 μm. In this case, the fifth separation distance D5 may be formed between the fifth reinforcing material 20e and the sixth reinforcing material 20f.

In this state, when the sixth reinforcing material 20f having a thickness of 10 μm is bonded to the electrode plate 10, the seventh reinforcing material 20g may be added in a position spaced apart from the sixth reinforcing material 20f by a separation distance greater than the fifth separation distance D5. In this manner, as the thickness of the reinforcing material 20 increases, the thickness of the electrode plate 10 increases, and as the thickness of the electrode plate 10 increases, the separation distance D between the reinforcing materials 20 may increase.

As another example, when a thickness of a +Y-direction end of the electrode plate 10 in the Z-axis direction is 5 μm thinner than a thickness of a −Y-direction end of the electrode plate 10 in the Z-axis direction, a thickness of the reinforcing material 20 added to the +Y-direction end in in the Z-axis direction may be 10 μm.

When the thickness of the +Y-direction end of the electrode plate 10 in the longitudinal direction (X-axis direction) is continuously thin, the plurality of reinforcing materials 20 may be added to the electrode plate 10.

In this case, when the thickness of one reinforcing material 20 in the Z-axis direction is 10 μm, the plurality of reinforcing materials 20 having a thickness of 10 μm may be separated by 10 cm in the longitudinal direction (X-axis direction) of the electrode plate 10.

On the other hand, when the thickness of one reinforcing material 20 in the Z-axis direction is 20 μm under the same conditions, the plurality of reinforcing materials 20 having a thickness of 20 μm may be separated by 30 cm in the longitudinal direction (X-axis direction) of the electrode plate 10.

Accordingly, even if a plurality of reinforcing materials 20 are intermittently added to the electrode plate 10, the effect of continuously increasing the thickness of the electrode plate 10 in the longitudinal direction of the electrode plate 10 may be obtained. Accordingly, the thickness of the electrode plate 10 may be uniformly reinforced while minimizing the number of reinforcing materials 20.

However, actual values of the first to sixth spacing distances D1, D2, D3, D4, D5 and D6 and an actual value of the thickness of the reinforcing material 20 may be appropriately selected and applied according to the thickness of the center C of the electrode plate 10, the first side thickness value T21, the second side thickness value T22, a width of the electrode plate 10, the speed at which the electrode plate 10 is supplied from the supply portion 110, or the like.

According to the disclosure stated above, a thickness deviation of the electrode plate 10 to which the electrode active material 30 has been applied may be corrected, and the thickness of the electrode plate 10 may be made uniform.

Additionally, the thickness of the electrode plate 10 may be made constant in the width direction of the electrode plate 10, and a thickness deviation between the center C of the electrode plate 10 and both ends of the electrode plate 10 may be eliminated. Additionally, the thickness deviation between both ends of the electrode plate 10 may also be eliminated.

Accordingly, when stacking or arranging the plurality of electrode plates 10 or winding the electrode plates 10, it may be possible to prevent the plurality of electrode plates 10 from being misaligned with each other or prevent one electrode plate 10 from being pushed or twisted. Additionally, even during a process in which the electrode plate 10 is transmitted to various processes before stacking or winding the electrode plate 10, it may be possible to prevent the electrode plate 10 from being twisted or moving away from a designated position.

Additionally, it may be possible to prevent unnecessary loss or damage of materials such as the electrode plate 10 and reinforcing material 20. This may contribute to improving the productivity of the electrode and electrode assembly and increasing a manufacturing yield of the electrode and the electrode assembly.

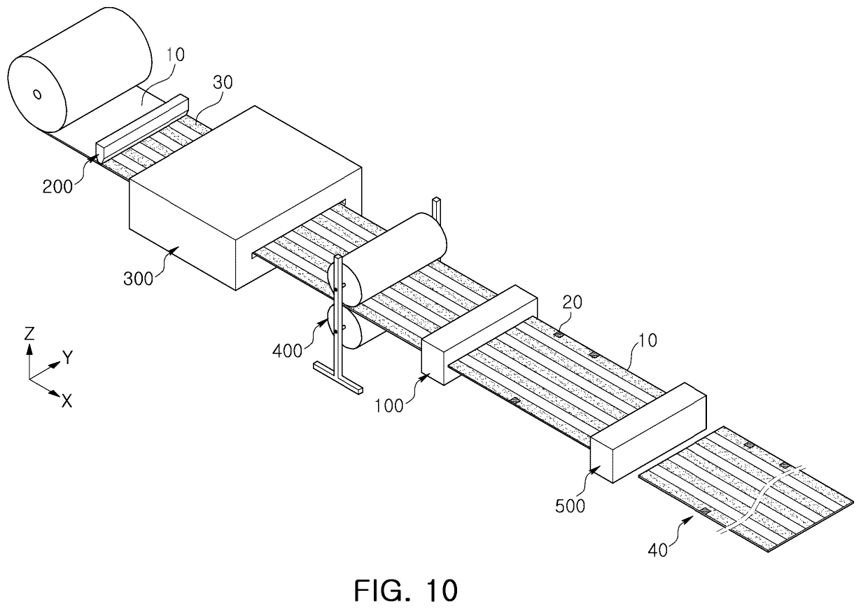

FIG. 10 is a schematic view of an electrode manufacturing system including an apparatus 100 for manufacture of an electrode according to an embodiment of the present disclosure. At least a portion of a process of the electrode manufacturing system is schematically illustrated in FIG. 10. Furthermore, in FIG. 10, the uncoated regions FA and FB (see FIG. 3) of the electrode plate 10 is omitted.

As illustrated in FIG. 10, the electrode manufacturing system may include a coating device 200, a drying device 300, a press device 400, an apparatus 100 for manufacturing an electrode, and a separating device 500 disposed along an electrode plate 10 that is unwound in a state of being rolled in a scroll form.

A roller or the like may be used to unwind the electrode plate 10, but the present disclosure is not necessarily limited thereto.

The electrode plate 10 prior to being supplied to the coating device 200 may not be coated with an electrode active material 30. The electrode plate 10 may be a positive electrode current collector or a negative electrode current collector.

The electrode plate 10 may be continuously supplied to the coating device 200, and the coating device 200 may apply or coat the electrode active material 30 to the electrode plate 10. The coating device 200 may apply or coat an electrode active material 30 to the electrode plate 10 with a certain pattern, a certain length, and the like.

The electrode plate 10 discharged from the coating device 200 may be provided with an active material, and the active material may be a positive electrode active material or a negative electrode active material.

The electrode plate 10 provided with the active material may be supplied to the drying device 300. The drying device 300 may perform a solvent drying process. The drying device 300 may include a chamber for drying.

The electrode plate 10 that has completed drying may be supplied to the press device 400 and then compressed. The press device 400 may include a plurality of rollers, and the electrode plate 10 may be pressed by the plurality of rollers. A length or a width of the plurality of rollers may be greater than or equal to a length or a width of the electrode plate 10. The plurality of rollers may pressurize the electrode plate 10 to reduce the thickness of the electrode plate 10.

The electrode plate 10 passing through the press device 400 may be supplied to the apparatus 100 for manufacturing an electrode. The apparatus 100 for manufacturing an electrode measures the thickness of the electrode plate 10, and when the thickness of the electrode plate 10 is uneven in the width direction of the electrode plate 10, a reinforcing material 20 may be added to the electrode plate 10 to correct the thickness of the electrode plate 10 on a constant level.

In this case, the reinforcing material 20 may be selectively added to the electrode plate 10 when the thickness of the electrode plate 10 is uneven.

The electrode plate 10 passing through the apparatus 100 for manufacturing an electrode may be supplied to the separating device 500 in a state in which the reinforcing material 20 is bonded thereto. The separating device 500 may cut the electrode plate 10 supplied in the form of a continuous single plate according to a certain standard and manufacture the cut electrode plate 10 into a unit electrode plate 40.

The apparatus 100 for manufacturing an electrode may perform an operation of correcting the thickness of the electrode plate 10 before manufacturing the electrode plate 10 into the unit electrode plate 40 by separating the electrode plate 10 into a unit length.

When it is confirmed in the apparatus 100 for manufacturing an electrode that a thickness value of the electrode plate 10 is at least equal to a preset value, the electrode plate 10 may be supplied to the separating device 500. The comparison of the thickness values of the electrode plate 10 may be performed by the controller 140.

The separating device 500 may cut the electrode plate 10 having a constant thickness into a unit length to manufacture the unit electrode plate 40. The unit electrode plate 40 may be transferred to a winding or stacking process. In the winding or stacking process, a plurality of unit electrode plates 40 may be wound or stacked together with a separator.

A separator may be interposed between the negative electrode plate 10 and the positive electrode plate 10, and the separator may be interposed between the negative electrode plate 10 and the positive electrode plate 10 through methods such as stacking, stacking & folding, Z-folding, or the like. Accordingly, an electrode assembly may be manufactured, and the number of negative electrode plates 10, positive electrode plates 10 and separators is not necessarily limited thereto.

At least one of the coating device 200, the drying device 300, the press device 400, the apparatus 100 for manufacturing an electrode and the separating device 500 may be implemented using a two-axis stage, a three-axis stage, a machining center, a CNC, a robot arm, various types of measuring sensors, a controller, a gear, a rail, a welder, an ultrasonic device, a laser device, a warning horn and an alarm device either alone or in combination.

The electrode manufacturing system may include a process of accommodating an electrode assembly including an electrode plate 10 in an outer material or a case, a can, or the like. The outer material or the case may be a film having a pouch shape. The can may have various shapes such as a square shape and a cylindrical shape, and materials thereof may also be diverse.

Additionally, the coating device 200, the drying device 300, the press device 400, the apparatus 100 for manufacturing an electrode and the separating device 500 may be used alone or in some combinations other than the electrode manufacturing system.

Additionally, the aforementioned electrode manufacturing process may be performed continuously, stepwise, and sequentially.

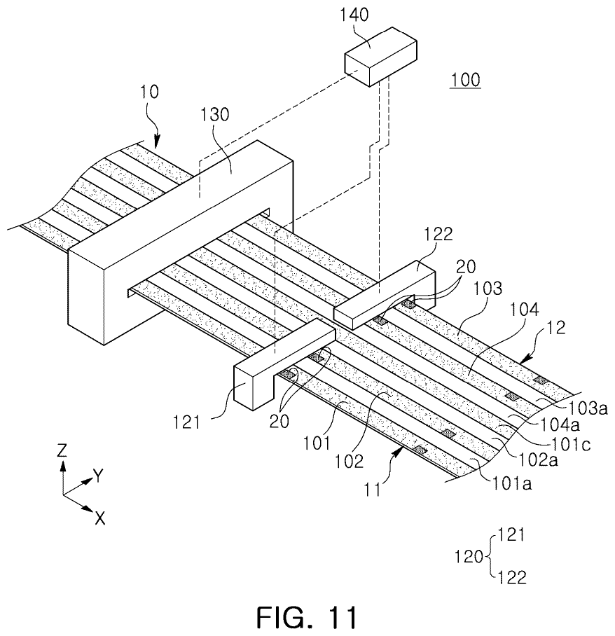

FIG. 11 schematically illustrates a portion of an electrode manufacturing system including an apparatus 100 for manufacture of an electrode according to another embodiment of the present disclosure. In FIG. 11, at least a portion of the electrode manufacturing system is schematically illustrated. Additionally, in FIG. 11, the uncoated regions FA and FB (see FIG. 3) of the electrode plate 10 is omitted.

As illustrated in FIG. 11, the electrode plate 10 may be applied to a cylindrical battery. The electrode plate 10 may be in the form of applying a positive electrode active material or a negative electrode active material to a positive electrode current collector or a negative electrode current collector.

For example, as illustrated in FIGS. 10 and 11 when the electrode plate 10 is formed by applying the positive electrode active material to the positive electrode current collector, the electrode plate 10 may be formed so that regions 101, 102, 103 and 104 to which the positive electrode active material is applied and regions 101a, 102a, 103a and 104a to which the positive electrode active material is not applied may be disposed in turn or alternately in a width direction, that is, in the Y-axis direction. In this case, the center C (see FIG. 3) of the electrode plate 10 may be provided in a center active material region 101c. The same principle as described above may be applied even if the electrode plate 10 is a negative electrode current collector.

In an embodiment, when the electrode plate 10 is a positive electrode plate including a positive electrode current collector, the positive electrode plate may be formed so that a region in which the positive electrode active material is applied and a region in which the positive electrode active material is not applied may be alternately disposed in a width direction (Y-axis direction) of the positive electrode plate, and when the electrode plate 10 is a negative electrode plate including a negative electrode current collector, the negative electrode plate may be formed so that a region in which the negative electrode active material is applied and a region in which the negative electrode active material is not applied may be alternately disposed in a width direction of the negative electrode plate.

For example, in the electrode plate 10, an active material region and an uncoated region may be alternately arranged in the width direction (Y-axis direction), and the electrode plate 10 may be stripe-coated in the length direction (X-axis direction). For example, the positive electrode active material may be stripe-coated in the length direction of the positive electrode plate, and the negative electrode active material may be stripe-coated in the length direction of the negative electrode plate.

In this case, based on the center C (see FIG. 3) of the electrode plate 10, as the active material region is closer to the first end 11 than the center C (see FIG. 3), a thickness value of the end of each active material region in the −Y-direction may be less than a thickness value of the end thereof in the +Y-direction.

That is, among the plurality of active material regions, a first active material region 101, an active material region closest to the first end 11, may have a thinner thickness of an end thereof in the −Y-direction than a thickness of an end thereof in the +Y-direction. An edge of the first active material region 101 in the −Y-direction may be included in the first end 11.

Additionally, in a second active material region 102, adjacent to the first active material region 101 and closer to the center C (see FIG. 3) than the first active material region 101, a thickness of an end thereof in the −Y-direction may be thinner than a thickness of an end thereof in the +Y-direction.

In this manner, as the active material region is closer to the first end 11, a Z-axis direction thickness of an edge of the corresponding active material region in the −Y-direction may be thinner than a Z-axis direction thickness of an edge thereof in the +Y-direction.

On the other hand, based on the center C (see FIG. 3) of the electrode plate 10, as the active material region is closer to the second end 12 than to the center C (see FIG. 3), a thickness value of the end of each to active material region in the +Y-direction may be less than a thickness value of the end thereof in the −Y-direction.

That is, among the plurality of active material regions, as the active material region is closer to the second end 12, a Z-axis direction thickness of an edge of the corresponding active material region in the +Y-direction may be thinner than a Z-axis direction thickness of an edge thereof in the −Y-direction.

That is, among the plurality of active material regions, a third active material region 103, an active material region closest to the second end 12, may have a thinner thickness of an end thereof in the +Y-direction than a thickness of an end thereof in the −Y-direction. In this case, the end of the third active material region 103 in the −Y-direction may be disposed closer to the center C (see FIG. 3) than the end thereof in the +Y-direction. An edge in the +Y-direction of the third active material region 103 may be included in the second end 12.

Additionally, in a fourth active material region 104, adjacent to the third active material region 103 and closer to the center C (see FIG. 3) than the third active material region 103, a thickness of an end thereof in the +Y-direction may be thinner than a thickness of an end thereof in the −Y-direction.

In this manner, as the active material region is closer to the second end 12, a Z-axis direction thickness of an edge of the corresponding active material region in the +Y-direction may be thinner than a Z-axis direction thickness of an edge thereof in the −Y-direction.

In this case, the first side reinforcing portion 121 and the second side reinforcing portion 122 may add the reinforcing material 20 to a region in which a thickness thereof is relatively thin in each active material region.

For example, the first side reinforcing portion 121 may face the first active material region 101 and the second active material region 102, and the first side reinforcing portion 121 may add the reinforcing material 20 to a region including an edge of the first active material region 101 in the −Y-direction and a region including an edge of the second active material region 102 in the −Y-direction.

Additionally, the second side reinforcing portion 122 may face the third active material region 103 and the fourth active material region 104, and the second side reinforcing portion 122 may add the reinforcing material 20 to a region including an edge of the third active material region 103 in the +Y-direction and a region including an edge of the fourth active material region 104 in the +Y-direction. According to an embodiment of the present disclosure, it may be possible to contribute to improving the quality of an electrode plate 10 optimized for a cylindrical battery.

Meanwhile, as another aspect, the present disclosure provides an electrode assembly including a plurality of electrode plates. The plurality of electrode plates may include a positive electrode plate and a negative electrode plate.

In this case, the plurality of electrode plates of an electrode assembly 1 may be manufactured by the apparatus for manufacturing an electrode described above.

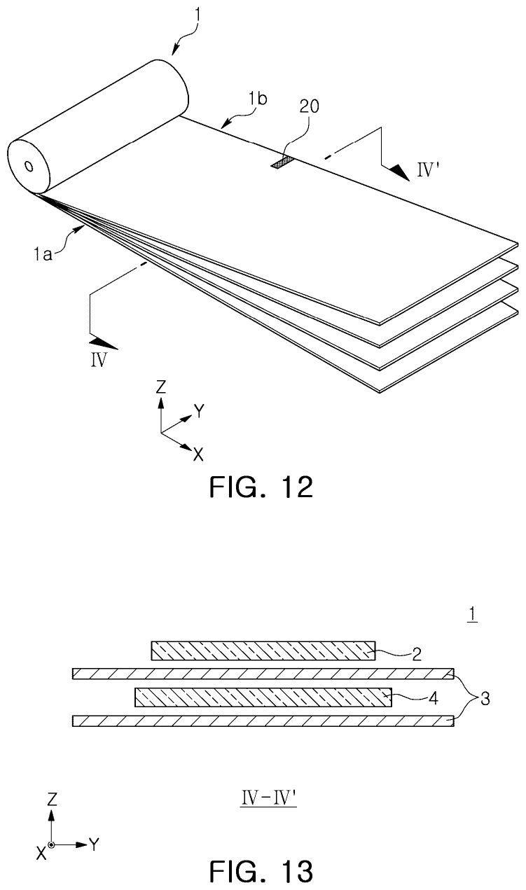

FIG. 12 is a schematic perspective view of an electrode assembly 1 according to an embodiment of the present disclosure, and FIG. 13 schematically illustrates a cross-section taken along line IV-IV′ of FIG. 12. FIG. 12 may be a state in which a positive electrode plate 2, a negative electrode plate 4, and a separator 3 are wound.

As illustrated in FIG. 12 and FIG. 13, an electrode assembly 1 according to an embodiment of the present disclosure includes a positive electrode plate 2 to which a positive active material is applied, a negative electrode plate 4 to which a negative active material is applied, and a separator 3 interposed between the positive electrode plate 2 and the negative electrode plate 4, and at least one of the positive electrode plate 2 and the negative electrode plate 4 include at least one reinforcing material 20 in at least a partial region thereof.

The electrode assembly 1 may include one end 1a and the other end 1b. The electrode assembly 1 may include a plurality of electrode plates, and the plurality of electrode plates may include the positive electrode plate 2 and the 5 negative electrode plate 4.

The one end 1a and the other end 1b of the electrode assembly 1 may be one end and the other end of the positive electrode plate 2 and the negative electrode plate 4 in the width direction.

In an example embodiment, at least one of the positive electrode plate 2 and the negative electrode plate 4 may be formed of a material including a reinforcing material in a region including the end.

The ends of the positive electrode plate 2 and the negative electrode plate 4 may include one end and the other end of the positive electrode plate 2 and the negative electrode plate 4. The one end and the other end may be edges of the positive electrode plate 2 and the negative electrode plate 4 in the width direction. Accordingly, the one end 1a and the other end 1b of the electrode assembly 1 may be one edge and the other edge of the positive electrode plate 2 and the negative electrode plate 4.

The reinforcing material 20 may be added to at least one of the one edge and the other end of the positive electrode plate 2, or to at least one of the one edge and the other end of the negative electrode plate 4. Additionally, the reinforcing material 20 may be added to all edges of both the positive electrode plate 2 and the negative electrode plate 4. However, the present disclosure is not necessarily limited thereto.

At least one reinforcing material 20 may be included in the form of a plurality of reinforcing materials 20 as needed. The reinforcing material 20 illustrated in FIG. 12 may be bonded to the other end 1b of the electrode assembly 1, and before bonding the reinforcing material 20, the electrode assembly may have a thickness of the other end 1b thinner than a thickness of the one end 1a.

In an embodiment, at least one reinforcing material 20 may be a material including at least one of aluminum, copper, nickel, titanium or stainless steel. Accordingly, the charge and discharge performance of the electrode assembly 1 may be prevented from being deteriorated, and the thickness of the electrode assembly 1 may be made uniform in the width direction. This may contribute to improving the quality of the electrode assembly 1.

In the case in which the electrode assembly 1 is provided with a plurality of positive plates 2 and a plurality of negative plates 4, a relatively long integral separator 3 may be folded in a zigzag manner and interposed between each positive plate 2 and negative plate 4. Alternatively, a plurality of separators 3 cut to a certain standard may be interposed between each positive plate 2 and negative plate 4. However, the present disclosure is not necessarily limited thereto.

Accordingly, the reinforcing material 20 provided on the positive plate 2 and the reinforcing material 20 provided on the negative plate 4 may also be mutually isolated by the separator 3. Accordingly, the electrical stability and safety in use of the electrode assembly 1 may be improved.

The contents described above are merely examples of applying the principles of the present disclosure, and other configurations may be further included or substituted and applied without departing from the scope of the present disclosure.

What is claimed is:

1. An apparatus for manufacturing an electrode, comprising:
a supply portion supplying an electrode plate to which an electrode active material is applied;
at least one thickness measuring portion measuring a thickness of the electrode plate; and
at least one thickness reinforcing portion adding at least one reinforcing material to the electrode plate.

2. The apparatus for manufacturing an electrode of claim 1, wherein the at least one thickness measuring portion measures a center thickness value, a thickness value of a region in which a center of the electrode plate is disposed in a thickness direction cross-section of the electrode plate, and a side thickness value, a thickness value of the electrode plate in at least one end of both ends of the electrode plate.

3. The apparatus for manufacturing an electrode of claim 1, wherein the at least one thickness reinforcing portion adds the at least one reinforcing material to a region including at least one end of both ends of the electrode plate in a thickness direction cross-section of the electrode plate.

4. The apparatus for manufacturing an electrode of claim 1, further comprising:
a controller connected to the at least one thickness measuring portion and the at least one thickness reinforcing portion,
wherein the at least one thickness measuring portion measures a center thickness value, a thickness value of a region in which a center of the electrode plate is disposed in a thickness direction cross-section of the electrode plate, and a side thickness value, a thickness value of the electrode plate in at least one end of both ends of the electrode plate, and
wherein the controller adds at least one reinforcing material to the at least one end with the at least one thickness reinforcing portion when the side thickness value is smaller than the center thickness value.

5. The apparatus for manufacturing an electrode of claim 1, wherein the at least one reinforcing material is a material including at least one of aluminum, copper, nickel, titanium, and stainless steel.

6. The apparatus for manufacturing an electrode of claim 1, wherein the at least one thickness measuring portion includes:
a first side measuring portion measuring a first side thickness value, a thickness of one end of the electrode plate; and
a second side measuring portion measuring a second side thickness value, a thickness of the other end of the electrode plate.

7. The apparatus for manufacturing an electrode of claim 6, wherein the at least one thickness reinforcing portion includes:
a first side reinforcing portion adding the at least one reinforcing material to one end of the electrode plate; and
a second side reinforcing portion adding the at least one reinforcing material to the other end of the electrode plate.

8. The apparatus for manufacturing an electrode of claim 7, further comprising:
a controller connected to the first side measuring portion, the second side measuring portion, the first side reinforcing portion, and the second side reinforcing portion,
wherein the controller adds the at least one reinforcing material to the first side reinforcing portion or the second side reinforcing portion when a measurement side thickness difference value, a difference value between the first side thickness value and the second side thickness value, is greater than or equal to a preset target side thickness difference value.

9. The apparatus for manufacturing an electrode of claim 1, wherein the at least one thickness measuring portion includes:
a thickness measuring member measuring the thickness of the electrode plate; and
a first actuator moving the thickness measuring member.

10. The apparatus for manufacturing an electrode of claim 1, wherein the at least one thickness measuring portion includes at least one of an ultrasonic thickness measuring device and a radiological thickness measuring device.

11. The apparatus for manufacturing an electrode of claim 1, wherein the at least one thickness measuring portion measures a thickness of the electrode plate during a transport of the electrode plate, and
the thickness reinforcing portion adds the at least one reinforcing material to the electrode plate during the transport of the electrode plate.

12. The apparatus for manufacturing an electrode of claim 1, wherein the at least one thickness reinforcing portion adds the at least one reinforcing material to the electrode plate passing through the at least one thickness measuring portion.

13. The apparatus for manufacturing an electrode of claim 1, wherein the thickness reinforcing portion adds a plurality of reinforcing materials to one electrode plate.

14. An electrode assembly, comprising:
a positive electrode plate to which a positive active material is applied;
a negative electrode plate coated to which a negative active material is applied; and
a separator interposed between the positive electrode plate and the negative electrode plate,
wherein at least one of the positive electrode plate and the negative electrode plate includes at least one reinforcing material in at least a partial region thereof.

15. The electrode assembly of claim 14,
wherein at least one of the positive electrode plate and the negative electrode plate includes at least one reinforcing material in a region including an end.

16. The electrode assembly of claim 14,
wherein the at least one reinforcing material is a material including at least one of aluminum, copper, nickel, titanium, and stainless steel.

17. The electrode assembly of claim 14,
wherein the positive electrode plate is formed so that a region to which the positive electrode active material is applied and a region to which the positive electrode active material is not applied are alternately arranged in a width direction of the positive electrode plate, and
wherein the negative electrode plate is formed so that a region to which the negative active material is applied and a region to which the negative active material is not applied are alternately arranged in the width direction of the negative electrode plate.

18. The electrode assembly of claim 17,
wherein in the positive electrode plate, the positive electrode active material is stripe-coated in a length direction of the positive electrode plate, and
wherein in the negative electrode plate, the negative electrode active material is stripe-coated in the length direction of the negative electrode plate.
